(19) United States
(12) Patent Application Publication
(10) Pub. No.: US 2011/0134241 A1
(43) Pub. Date: Jun. 9, 2011

(54) AUDIO VIDEO INTERNET MONITORING SYSTEM

(75) Inventor: Alan M. Weissman, Williamsville, NY (US)

(73) Assignee: Mr. Alan Michael Weissman, Williamsville, NY (US)

(21) Appl. No.: 12/954,905

(22) Filed: Nov. 28, 2010

Related U.S. Application Data
(60) Provisional application No. 61/267,078, filed on Dec. 6, 2009.

(51) Int. Cl. H04N 7/18

(52) U.S. Cl. 348/143; 348/E07.085

(57) ABSTRACT

A video and audio surveillance and monitoring system having one or more IP camera devices placed in premises to monitor the movements, actions and sounds of a person or pet to verify their well being or to indicate the need for assistance or intervention. The ability of remotely located persons or entities to view and talk back to, simultaneously, the premises of concern on a computer display or web enabled portable device. The ability to access the premises from any internet connected web browser. The ability for the end-user to, easily, install this system without the need for computers, servers or active computer software applications, in the monitored premises. The ability to, easily, install this system in any dwelling or premises that has an Internet connection. To provide the end user with a custom configured system of one or more camera devices with synchronous audio connected by cables or wirelessly to a premises gateway/router.

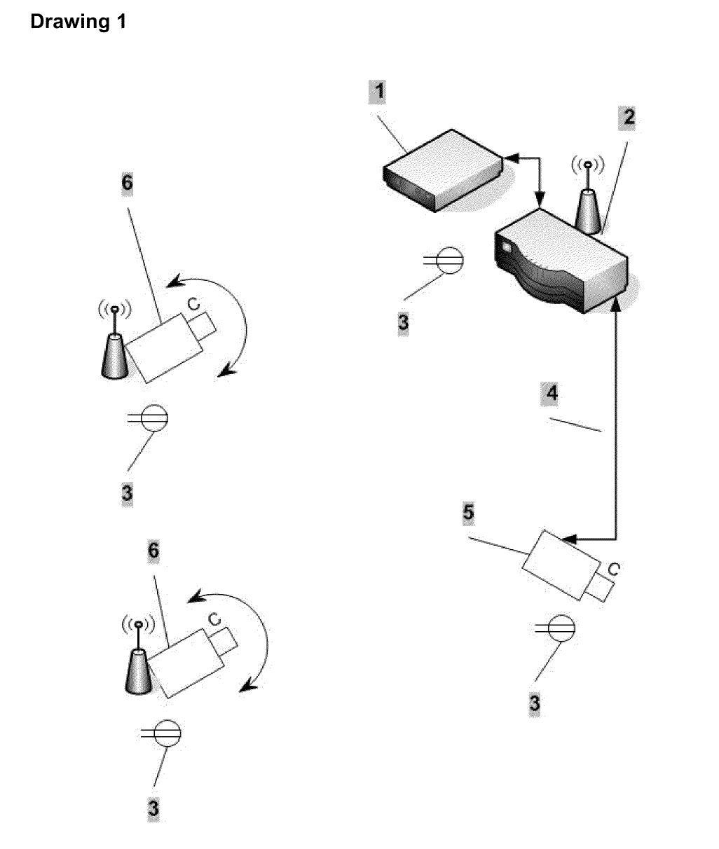

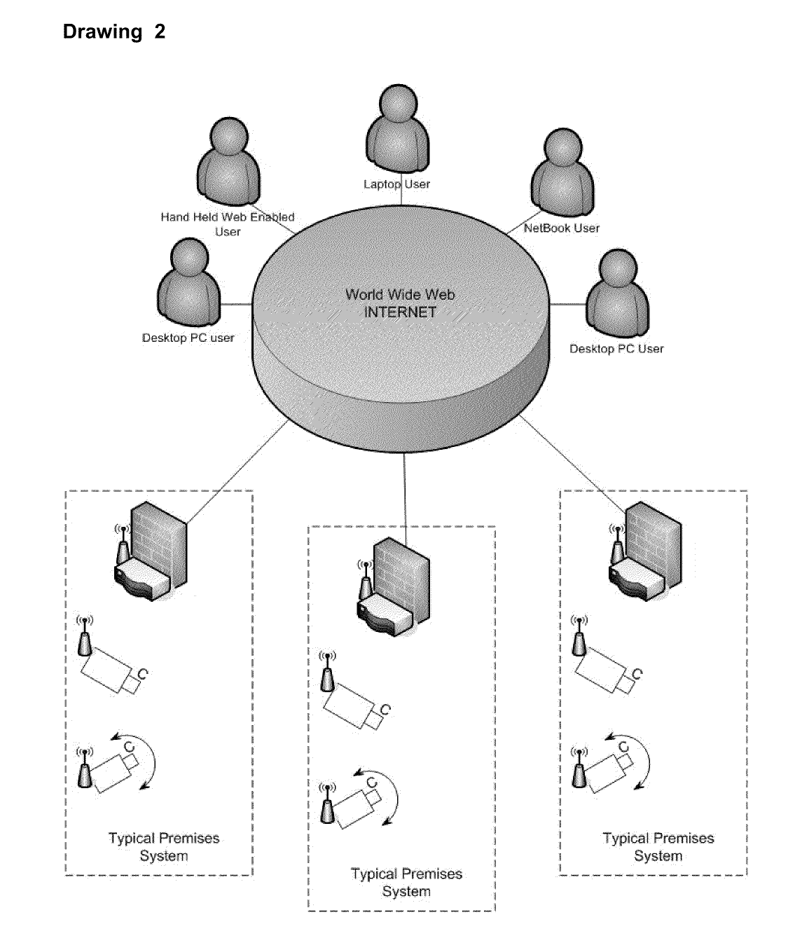

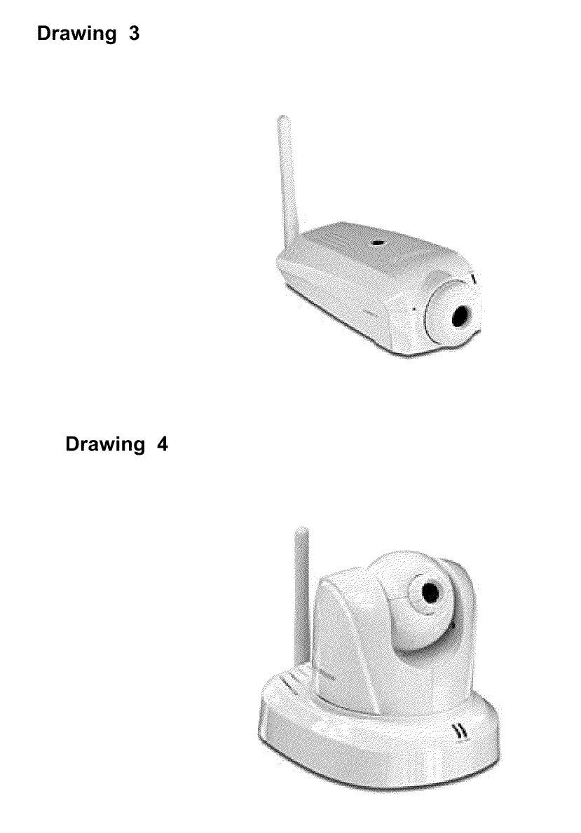

### FIELD OF THE INVENTION

The present invention relates to monitoring devices or systems and more particularly pertains to a to networked audio-video surveillance system with remote access. This invention cross references and relates to the provisional patent application No. 61/267,078 for the same invention, on the filing date Dec. 6, 2009.

### BACKGROUND OF THE INVENTION

There is presently a need to be able to easily monitor the well being of persons, pets and property by concerned parties. The intention of this invention is to help enable an aging population to remain at home longer. Being able to, instantly in real time, monitor a dwelling both visually and audibly from anywhere in the world, provides a caregiver or concerned party the first hand knowledge of the condition of a person or pet. This invention provides a system of single or multiple high resolution video images with integrated ambient sound to be monitored on a computer display or internet/web enabled mobile communications device. The system also provides an audio “talkback” system from the monitor to the dwelling. There is a need for a stable system which provides simple setup and operation. There is a need for a system which does not utilize a computer, application/file servers in the premises to be monitored. There is a need for a system which does not utilize third party surveillance services to be functional. A simple system would require only an Internet connection at the dwelling or premises to be monitored. There needs to be username and password protection for privacy.

The problem with the current methods of video monitoring is that all the systems, available to non network proficient users, utilize remote access systems that require a computer or server and an active software application running on a computer at the premises to be monitored and sometimes, additionally, a third party interface system on the public network. This presents a variety of problems such as the need for a technical or computer savvy person to remedy any malfunctions at the premises. Also a computer and application need to be constantly running. Infirmed or aging people and obviously pets do not typically have the ability or desire to deal with computer outages and restarts.

Many prior attempts have been made to mitigate the problems associated with verifying the safety and well being of people and pets from remote locations. For example: U.S. Pat. No. 6,995,664 to Darling describes the use of a remote supervision system and method. U.S. Pat. No. 7,409,045 to Naidoo describes the use of a Lifestyle multimedia security system;—and U.S. Pat. No. 7,624,028 to Brown describes the use of Remote health monitoring and maintenance system.

Thus it is readily apparent that there is a longfelt need for utilizing video surveillance systems to remotely monitor people and pets, using only an IP video camera or cameras with integrated audio, an internet connection and wireless/wired router at the monitored premises.

### SUMMARY OF THE INVENTION

It is a primary object of the present invention to provide self installed and simple to operate video/audio monitoring system.

It is a primary object of the present invention to transmit video and audio over a network without a premises computer.

Another object of the present invention is to provide high resolution, real-time video images with synchronized sound to a remote location.

Another object of the invention is to provide a means to communicate audio back to the monitored premises.

Another object of the invention is to utilize the public internet network as a means of connectivity

It is a further object to provide such a system as to use internal IP video camera web browsing for monitoring

It is still a further object to provide remote monitoring from any computer connected to the internet

It is another object of the invention to provide remote monitoring from any web or video enabled mobile handheld communications device.

It is still another object to provide a system of single or multiple IP video cameras with integrated microphones.

Another object of the invention is to provide connectivity to one or more IP video cameras through an internet network connection to a wireless or wired residential gateway/router.

Another object of the invention is to make the WAN connection from the premises to the remote monitoring computer without the need for third party servers, applications or hired services. Dynamic Domain Name Services may be utilized for simplified and continuous connectivity.

Another object of the invention is to enable two way communications through a gateway/router using port forwarding and or NAT redirection configurations and techniques.

Still another object of the invention is to provide username and password protection for remote clients to access premises cameras.

### BRIEF DESCRIPTION OF THE DRAWINGS

DRAWING 1 is a typical system diagram

DRAWING 2 is a network connectivity block diagram

DRAWING 3 is a preferred embodiment of the present invention showing a typical fixed view and focal length wired/wireless IP video cameras

DRAWING 4 is a preferred embodiment of the present invention showing a typical Pan, Tilt, Zoom wired/wireless IP video camera

### DETAILED DESCRIPTION OF THE INVENTION

At the outset, it should be clearly understood that like reference numerals are intended to identify the same elements, portions, or items consistently throughout the several drawing figures, as may be further described or explained by the entire written specification of which this detailed description is an integral part. The illustrations are intended to be read together with the specification and are to be construed as a portion of the entire “written description” of this invention as required by 35 U.S.C. 112.

What follows is a description of a preferred embodiment of the invention illustrating the best mode of the invention known to the patentee at the time of application. The claims are not intended to be limited in scope to the preferred embodiment described herein, but rather are intended to encompass variations thereof which are readily apparent to those having ordinary skill in the art. For example, although the preferred embodiment depicted is suitable for a residential dwelling, it is conceivable that camera placement can be anywhere an entity is concerned about the well being of people places and things.

The preferred embodiment of the present invention is a video and audio monitoring system. The system utilizes commercially available IP network video surveillance camera devices. The cameras are connected to an internet router/gateway via wireless or cabled connection. The real time video and audio content of the camera can be linked to a remote computer or hand-held web or video enabled device display. The remote user can log on to the cameras internal web browser and view its contents. The remote user can enter a user name and password combination for access. The remote user can access a particular premises camera or cameras by pointing its internet web browser application to the preconfigured IP address of a premises modem or network interface and simultaneously entering a port number for that particular camera. A unique domain name may be used as a premises IP address and camera port number as a convenient way to point to the above stated IP address and port number if desired and utilized. A dynamic DNS service may be utilized to track the modems or network interface's dynamic public IP address. Each camera in a dwelling or premises will be configured with a static internal LAN IP address and a port number. The external computer of the remote user will browse and point to the unique internet IP address of the particular gateway/router at the desired premises. The gateway/router will be configured to allow port mapping and or NAT redirection. The cameras assigned IP address and port number will allow bi-directional connectivity through the software firewall of the gateway/router and through to the particular camera's internal web browser page.

Adverting now to the Drawings, Drawing 1 is a diagram of a typical premises system. It shows all the necessary components for a remote user to view, listen and talkback to a premises to monitor the condition of the occupants and premises. It illustrates the signal flow and individual components.

The present invention is comprised of: A (1) Broadband Cable or DSL or FIOS modem. This is the, subscribed to, link from the premises to the internet. It typically is assigned an IP address by the provider which can change periodically.

A (2) gateway/router with wireless and wired Ethernet distribution and connectivity to premises devices. They typical gateway/router utilizes a wired Ethernet connection at its WAN or Internet port to the (1) modem. The Typical gateway/router supplies multiple IP addresses to connected downstream devices. Those IP addresses can be static or dynamic. The typical gateway/router has an integrated configuration application. The configuration application allows for, in this invention, port mapping or NAT redirection. This customized port mapping allows for routing of external bidirectional traffic from the Internet to a particular camera/microphone/speaker device.

All the components in Drawing 1 are powered through a (3) convenience outlet. A manufacturer supplied power supply or direct connected power cord, is plugged in and provides the necessary power for the device electronics.

One of the premises (5) cameras in Drawing 1 shows an Ethernet (4) cable connection to the (2) gateway/router. The camera (5) is typical of a, commercially available, manufactured camera with a fixed focal length lens, an internal microphone and an Ethernet port for network connectivity.

Two of the (6) cameras in Drawing 1 show wireless connectivity to the (2) gateway router. The cameras (6) are typical of a many commercially available manufactured cameras with servo controlled positioning such as pan and tilt, and an optical zoom or digital zoom lens. They can include an integrated microphone and connector for an external speaker for bidirectional synchronous audio communications. They are Ethernet connected to the premises network with either a wired or wireless connection.

Drawing 2 is a functional block diagram of Wide Area Network. It shows how the Internet and the World Wide Web are utilized to allow geographically remote users to connect to, view, listen, and talkback to any premises so configured in Drawing 1. The premises in Drawing 2 have to be configured in the way designed for this invention and the user must possess the correct username and password information unique to a particular premises. The typical user can be a desktop computer, laptop computer, net book computer or handheld mobile device. These above mentioned user devices must be able to be connected to the internet via a wired or wireless connection. Drawing 2 shows typical premises with the router/gateway portrayed with an integrated firewall. The embodiment of this invention enables the penetration of this firewall with the custom configuration of the router/gateway. This configuration relies on IP addresses and port forwarding. This invention allows for bidirectional communications between the users in Drawing 2 and the premises in Drawing 2 without the need for on-premises computers and computer applications.

Drawing 3 displays a typical commercially available IP or Internet video camera of the fixed focal length design. It can be connected to the LAN in a wired or wireless configuration. It incorporate an integrated microphone and the ability to connect an external speaker for talk back purposes.

Drawing 4 displays a typical commercially available IP or Internet video cameras of the pan, tilt and zoom (PTZ) design. It can be connected to the premises LAN in a wired or wireless configuration. It incorporates an integrated microphone and the ability to connect an external speaker for talk back purposes.

It is will thus be seen that the objects set forth above, among those made apparent from the preceding description, are effectively attained and, since certain changes may be made in the above construction without departing from the spirit and scope of the invention, it is intended that all matter contained in the above description or shown in the accompanying drawings, shall be interpreted as illustrative and not in a limiting sense. It is also to be understood that the following claims are intended to cover all the generic and specific features of the invention herein described, and all statements of the scope of the invention which, as a matter of language, might be said to fall there between. While preferred embodiments of the present invention have been disclosed, it will be appreciated that the present invention can be otherwise embodied within the scope of the following claims.

1. A video and audio surveillance and monitoring device for premises having a person, pet or property that needs to be monitored for their own well being.

2. The remote display device of claim one wherein said entities can view and listen to, in real time, from a remote internet enabled computer display or device.

3. A remote accessed video and audio premises monitoring system that does not require services from a commercial security or surveillance system provider.

4. The surveillance device of claim one wherein said cameras are configured with static IP addresses and port numbers and port mapping as to allow remote access from the public Internet network.

5. The surveillance device of claim four wherein said cameras are enabled with microphones for audio monitoring

6. The surveillance device of claim four and wherein said cameras are equipped with an external speaker for “talkback audio from a microphone connected to the remote user device.

7. The surveillance device of claim four wherein said cameras are connected wirelessly or wired by cables to a gateway/router in the premises for connectivity to the Internet.

8. The surveillance devices of claim four wherein said are positioned in a premises as to cover an area of interest as to give a broad view of the object of concern.

9. The surveillance device of claim four wherein said cameras are connected to a power outlet with their supplied external power supply.

10. The surveillance device of claim seven wherein said gateway/router is connected to a public network through a subscribed Internet service in the premises.

11. The display device of claim two wherein said remote communication display such as an internet connected computer or web enabled hand held communications device can access the video/audio content of the premises networked video camera.

12. The remote device of claim two wherein said remote device can connect to the premises to be monitored via a unique user name and password access code.

13. The surveillance device of claim one wherein said system enables single or multiple simultaneous remote users to monitor the status, visually and audibly, of a person, place or thing of concern with only a premises IP video camera, a gateway/router and a Internet connection.
